(19) United States
(12) Patent Application Publication
(10) Pub. No.: US 2025/0096281 A1
(43) Pub. Date: Mar. 20, 2025

(54) ELECTRODE, SECONDARY BATTERY, BATTERY PACK, VEHICLE, AND STATIONARY POWER SUPPLY

(71) Applicant: KABUSHIKI KAISHA TOSHIBA, Tokyo (JP)

(72) Inventors: Yasunobu YAMASHITA, Meguro Tokyo (JP); Keigo HOSHINA, Yokohama Kanagawa (JP)

(73) Assignee: KABUSHIKI KAISHA TOSHIBA, Tokyo (JP)

(21) Appl. No.: 18/777,156

(22) Filed: Jul. 18, 2024

(30) Foreign Application Priority Data
Sep. 20, 2023 (JP) 2023-151956

(51) Int. Cl. H01M 4/80; B60L 50/64; H01M 4/02; H01M 4/66; H01M 10/36

(52) U.S. Cl. CPC H01M 4/801; B60L 50/64; H01M 4/661; H01M 4/806; H01M 10/36; H01M 2004/021; H01M 2004/027; H01M 2004/028; H01M 2220/10; H01M 2220/20

(57) ABSTRACT

An electrode includes a current collector and an active material-containing portion. The current collector has a first porosity, and the electrode including the current collector and the active material-containing portion has a second porosity. The first porosity is 70% or more and 90% or less and the second porosity is 60% or more and 80% or less.

### CROSS-REFERENCE TO RELATED APPLICATIONS

This application is based upon and claims the benefit of priority from Japanese Patent Application No. 2023-151956 filed on Sep. 20, 2023, and the entire contents of which are incorporated herein by reference.

### FIELD

Embodiments described herein relate generally to an electrode, a secondary battery, a battery pack, a vehicle, and a stationary power supply.

### BACKGROUND

In order to increase the capacity of a secondary battery, for example, it has been proposed to increase the amount of an active material applied to a current collector to thicken an electrode.

However, when a coating amount is increased, a porosity of the electrode is decreased, and thus poor impregnation with an electrolyte occurs, and charge and discharge performance deteriorate.

As a result, an actually obtained energy density is lower than a designed energy density.

Therefore, there is a limit to increase the capacity.

### BRIEF DESCRIPTION OF THE DRAWINGS

FIG. 1 is a schematic view schematically showing an example of a current collector in an electrode according to an embodiment.

FIG. 2 is a schematic view schematically illustrating an example of the electrode according to an embodiment.

FIG. 3 is a schematic view schematically illustrating another example of the electrode according to an embodiment.

FIG. 4 is a schematic view schematically illustrating still another example of the electrode according to an embodiment.

FIG. 5 is a cross-sectional view schematically illustrating an example of a secondary battery according to an embodiment.

FIG. 6 is a schematic cross-sectional view taken along line II-II of the secondary battery illustrated in FIG. 5.

FIG. 7 is a partially cut-out t perspective view schematically illustrating another example of the secondary battery according to an embodiment.

FIG. 8 is a sectional view in which a part E of the secondary battery illustrated in FIG. 7 is enlarged.

FIG. 9 is a perspective view schematically illustrating an example of an assembled battery according to an embodiment.

FIG. 10 is an exploded perspective view schematically illustrating another example of a battery pack according to an embodiment.

FIG. 11 is a block diagram illustrating an example of an electric circuit of the battery pack illustrated in FIG. 10.

FIG. 12 is a partial transparent view schematically illustrating an example of a vehicle according to an embodiment.

FIG. 13 is a block diagram illustrating an example of a system including a stationary power supply according to an embodiment.

### DETAILED DESCRIPTION

Hereinafter, embodiments will be described with reference to the drawings. Note that, the same reference numerals will be given to a common configuration throughout the embodiments, and redundant description will be omitted. In addition, each drawing is a schematic view for promoting description of the embodiments and understanding thereof, and shapes, dimensions, ratios, and the like are different from those of actual devices, but these can be appropriately modified in design in consideration of the following description and known techniques.

### First Embodiment

According to a first embodiment, an electrode is provided. The electrode includes a current collector and an active material-containing portion. A first porosity of a current collector is 70% to or more and 90% or less, and a second porosity of the electrode is 60% or more and 80% or less. Here, the first porosity refers to a porosity of the current collector. The second porosity refers to a porosity of the electrode including the current collector and the active material-containing portion. A void refers to a space existing between members of the current collector or the electrode.

Since the first porosity is 70% or more and 90% or less, a specific surface area of the current collector is large, and the amount of the active material that can be supported increases, and thus it is possible to provide an electrode capable of realizing a secondary battery having a high capacity. In addition, the fact that the second porosity is 60% or more and 80% or less indicates that a high porosity is obtained even in a state of containing the active material, and thus the inside of the electrode can be impregnated with an electrolyte. By impregnating the inside of the electrode with the electrolyte and enhancing a reactivity with the active material supported on the current collector, it is possible to provide an electrode capable of realizing a secondary battery having excellent charge and discharge performance.

Hereinafter, electrode according to the embodiment will be described in detail. The electrode according to the embodiment can be used as a positive electrode or a negative electrode.

The electrode includes a current collector and an active material-containing portion. The active material-containing portion contains an active material.

### <Current Collector>

It is desired that the current collector has a porosity of 70% or more and 90% or less, and has voids on a surface and at the inside of the current collector. It is desired that voids of the current collector are ubiquitous.

As the material of the current collector, for example, a material that is electrochemically stable at a potential at which lithium (Li) or sodium (Na) is inserted into and extracted from the active material is used. For example, the material is a metal or a composite material. When the current collector contains a metal, copper, nickel, stainless steel, aluminum, or an aluminum alloy containing one or more elements selected from the group consisting of Mg, Ti, Zn, Mn, Fe, Cu, and Si can also be selected. When the current collector is a composite material, a porous material obtained by mixing a resin with a fibrous conductive material such as carbon nanotubes and press-molding the mixture can be used. As the resin, polyethylene, polypropylene, polyethylene terephthalate, polyacrylonitrile, polymethyl methacrylate, polyvinylidene fluoride, and the like can be used. The conductive material and the resin may be one kind or two or more kinds.

The composite material can also be produced by using, for example, an electrospinning method. A current collector having a large specific surface area and a high porosity can be obtained by using the method. In addition, sufficient conductivity can be imparted by further performing a carbonization treatment or the like.

When the current collector is used as an electrode of a battery, it is desirable that the current collector has a sheet shape. The thickness is desirably 1 mm or more and 50 mm or less. According to this, a three-dimensional conductive path can be formed.

In an internal structure of the current collector, it is desirable that voids have a high porosity per unit volume of the current collector. For example, a sponge-like porous material or a material having a network structure can be used.

As the material having the network structure, for example, a mesh-like material, a nonwoven fabric, a material in which fibers such as steel wool are entangled, and the like can also be used.

When the current collector contains a metal fiber (hereinafter, referred to as a metal fiber), it is desirable that the current collector contains at least one or more kinds of metals selected, for example, from the group consisting of copper, nickel, aluminum, titanium, zinc, iron, and stainless steel. In a battery having an electrolyte containing water, when a current collector containing a metal fiber is used as a part of a positive electrode, it is desirable to select titanium having excellent corrosion resistance.

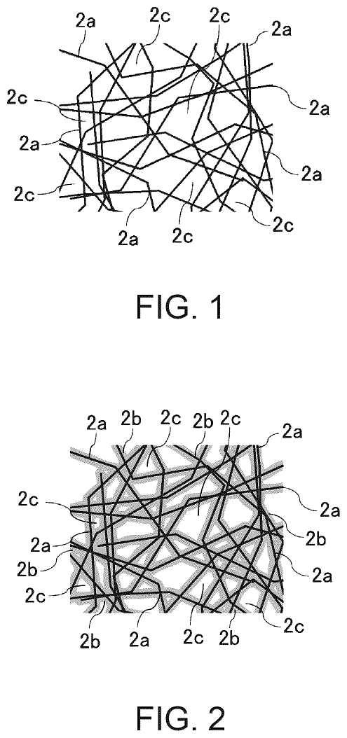

FIG. 1 is a schematic view of a metal fiber as an example of the current collector. In metal fibers 2a shown in FIG. 1, elongated string-like fibers three-dimensionally intersect each other and are gathered together to form a sheet. The metal fibers 2a may or may not intersect each other a plurality of times. A void 2c is formed by the intersection of the metal fibers 2a.

A fiber diameter of the metal fiber is desirably 1 μm or more and 100 μm or less. As a result, a specific surface area of the current collector is increased, and the active material can be further supported, so that charge and discharge performance can be improved.

In addition, in a depth direction of the current collector, a path that can travel from one surface to the opposite surface via any void can be visualized by a method described later. When a movement length of the path is set as f and the thickness in the depth direction is set as s, a curved path ratio r of the path can be calculated. An average of all void paths is expressed as the average curved path ratio. The average curved path ratio of the current collector is desirably 1.3 or more and 2.5 or less from the viewpoint of supporting properties of the active material-containing portion. The curved path ratio is also referred to tortuosity or degree of curvature.

The first porosity is 70% or more and 90% or less. When the first porosity is within this range, it is possible to support the active material-containing portion while maintaining the current collection performance.

The current collector may include a portion where the active material-containing portion is not formed on the surface or in the void. This portion can serve as a current collecting tab or a current collecting lead.

### <Active Material-Containing Portion>

The active material-containing portion is supported on the current collector and includes an active material. The active material-containing portion may contain a conductive agent or a binder. The active material-containing portion of the current collector may cover a surface of the current collector, but is preferably ubiquitous in the current collector.

FIG. 2 is a schematic view illustrating an example of a relationship between the current collector of the electrode and the active material-containing portion according to an embodiment. In the drawing, a case where the current collector includes metal fibers will be described. An active material-containing portion 2b shown in FIG. 2 contains an active material (not illustrated), a binder (not illustrated), and a conductive agent (not illustrated). The active material-containing portion 2b is supported on the surface of the metal fibers 2a. The active material-containing portion 2b can also be supported so as to fill a portion where the metal fibers 2a intersect each other or the void 2c formed by the metal fibers 2a.

The current collector 2 can include a plurality of the voids 2c formed by the metal fibers 2a and the active material-containing portion 2b, and the surface of the current collector 2 or the voids 2c can be impregnated with an electrolyte (not shown).

The second porosity including the current collector and the active material-containing portion is 60% or more and 80% or less. When the second porosity is within this range, the electrolyte can be impregnated into the electrode even when a high-viscosity electrolyte is used.

### <Negative Electrode Active Material>

When the electrode according to the embodiment is used as a negative electrode, a negative electrode active material is contained in the active material-containing portion. The negative electrode active material contains a Ti-containing composite oxide. The Ti-containing oxide is capable of absorbing and releasing Li ions (Li+). The Ti-containing oxide may be an oxide that further contains Li or an oxide that does not contain Li. The Ti-containing oxide that does not contain Li does not contain Li at the time of oxide synthesis, before an absorption and release reaction of lithium ions (Li+) occurs, or before a charge and discharge reaction occurs. Li may remain in the Ti-containing oxide due to an absorption and release reaction of lithium ions or an irreversible reaction generated during the charge and discharge reaction.

Examples of the Ti-containing oxide include a lithium titanium-containing oxide, a niobium titanium-containing oxide, and a titanium oxide. When at least one of the niobium-titanium-containing oxide and the titanium oxide is used as the negative electrode active material, for example, a high electromotive force can be obtained by combining with a lithium-manganese composite oxide or a lithium-nickel-cobalt-manganese composite oxide as the positive electrode active material. In addition, since a lithium ion insertion and extraction reaction of the niobium titanium-containing oxide is a solid solution reaction, there is a range in an operating potential of the electrode containing the niobium titanium-containing oxide. For example, the operation potential of an electrode containing a niobium titanium-containing oxide containing a crystal phase expressed as TiNb₂O₇ has a range of approximately 1.7 V to approximately 0.7 V. On the other hand, the operation potential of an electrode containing a lithium titanium-containing oxide such as Li₄Ti₅O₁₂ is constantly 1.55 V. Therefore, since the negative electrode containing the niobium titanium-containing oxide can set the negative electrode potential to a potential at which film formation is likely to occur, formation of a nitrogen-containing compound in the negative electrode active material-containing portion can be promoted.

Examples of the lithium titanium-containing oxide include a lithium titanium oxide having a spinel structure (for example, a general formula Li₄₊ₓTi₅O₁₂ (x satisfies a relationship of −1≤x≤3)), a lithium titanium oxide having a ramsdellite structure (for example, Li₂₊ₓTi₃O₇ (−1≤x≤3)), Li₁₊ₓTi₂O₄ (0≤x≤1), Li_{1.1+x}Ti_{1.8}O₄ (0≤x≤1), Li_{1.07+x}Ti_{1.86}O₄ (0≤x≤1), and LiₓTiO₂ (0<x≤1). The lithium titanium-containing oxide may be a lithium titanium composite oxide into which a different element is introduced.

Examples of the niobium titanium-containing oxide include oxides containing at least one crystal phase selected from the group consisting of TiNb₂O₇, Ti₂Nb₂O₉, Ti₂Nb₁₀O₂₉, TiNb₁₄O₃₇, and TiNb₂₄O₆₂. The niobium-titanium-containing oxide may be a substituted niobium-titanium composite oxide in which at least a part of Nb and/or Ti is substituted with a different element. Examples of the substitution element include Na, K, Ca, Co, Ni, Si, P, V, Cr, Mo, Ta, Zr, Mn, Fe, Mg, B, Pb, and Al. The substituted niobium-titanium composite oxide may contain one kind of substitution element or two or more kinds of substitution elements. Active material particles may contain one kind of niobium titanium-containing oxide or may contain a plurality of kinds of niobium titanium-containing oxides. The niobium titanium-containing oxide preferably contains Nb₂TiO₇ having a monoclinic structure. In this case, an electrode having excellent capacity and rate performance can be obtained.

Examples of the niobium titanium-containing oxide having a monoclinic structure include a compound expressed as LiₓTi_{1-y}M1_{y}Nb_{2-z}M2_{z}O_{7+δ}. Here, M1 is at least one selected from the group consisting of Zr, Si, and Sn. M2 is at least one selected from the group consisting of V, Ta, and Bi. The subscripts in the composition formula satisfy relationships of 0≤x≤5, 0≤y<1, 0≤z<2, and −0.3≤δ≤0.3.

Another example of the niobium titanium-containing oxide having the monoclinic structure is an oxide expressed as LiₐTiM_{b}Nb_{2+β}O_{7+σ} (0≤a≤5, 0≤b≤0.3, 0≤β≤0.3, 0≤σ≤0.3, and M is at least one kind of element selected from the group consisting of Fe, V, Mo, and Ta).

The titanium oxide includes, for example, a titanium oxide having a monoclinic structure, a titanium oxide having a rutile structure, and a titanium oxide having an anatase structure. In the titanium oxide having each crystal structure, a composition before charge can be expressed as TiO₂, and a composition after charge can be expressed as LiₓTiO₂ (x satisfies a relationship of 0≤x≤1). The structure of the titanium oxide having a monoclinic structure before charge can be expressed as TiO₂(B).

The kind of the negative electrode active material can be one kind or two or more kinds.

The negative electrode active material is contained in the negative electrode active material-containing portion in a form of, for example, particles. The negative electrode active material particles may be primary particles, secondary particles as aggregates of the primary particles, or a mixture of single primary particles and secondary particles. A shape of the particles is not particularly limited, and can be, for example, a spherical shape, an elliptical shape, a flat shape, a fibrous shape, or the like.

The average particle size (diameter) of the primary particles of the negative electrode active material is preferably 1 μm or less and more preferably 0.01 μm or more and 0.1 μm or less. The average particle size (diameter) of the secondary particles of the negative electrode active material is preferably 10 μm or less and more preferably 1 μm or more and 5 μm or less.

### <Positive Electrode Active Material>

When the electrode according to the embodiment is used as a positive electrode, a positive electrode active material is contained in the active material-containing portion. As the positive electrode active material, a compound having a lithium ion absorption and release potential of 3 V (vs. Li/Li⁺) or more and 5.5 V (vs. Li/Li⁺) or less as a potential based on metal lithium can be used. The positive electrode may contain one kind of positive electrode active material, or may contain two or more kinds of positive electrode active materials.

Examples of the positive electrode active material include a lithium-manganese composite oxide, a lithium-nickel composite oxide, a lithium-cobalt-aluminum composite oxide, a lithium-nickel-cobalt-manganese composite oxide, a spinel type lithium-manganese-nickel composite oxide, a lithium-manganese-cobalt composite oxide, a lithium-iron oxide, a lithium fluorinated iron sulfate, and a phosphate compound having an olivine crystal structure (for example, LiₓFePO₄ (0<x≤1) and LiₓMnPO₄ (0<x≤1)). The phosphate compound having an olivine crystal structure is excellent in thermal stability.

Examples of positive active materials from which a high positive electrode potential can be obtained include lithium-nickel-cobalt-manganese composite oxides (LiₓNi_{1-y-z}CO_{y}Mn_{z}O₂; 0<x≤1, 0<y<1, 0<z<1, y+z<1), lithium-manganese composite oxides such as LiₓMn₂O₄ (0<x≤1), LiₓMnO₂ (0<x≤1) having a spinel structure, lithium-nickel-aluminum composite oxides such as LiₓNi_{1-y}Al_{y}O₂ (0<x≤1, 0<y<1), lithium-cobalt composite oxides such as LiₓCoO₂ (0<x≤1), lithium-nickel-cobalt composite oxides such as LiₓNi_{1-y-z}Co_{y}Mn₂O₂ (0<x≤1, 0<y<1, 0≤z<1), lithium-manganese-cobalt composite oxides such as LiₓMn_{y}Co_{1-y}O₂ (0<x≤1, 0<y<1), spinel-type lithium-manganese-nickel composite oxides such as LiₓMn_{1-y}Ni_{y}O₄ (0<x≤1, 0<y<2, 0<1−y<1), lithium phosphorus oxides having an olivine structure such as LiₓFePO₄ (0<x≤1), LiₓFe_{1-y}Mn_{y}PO₄ (0<x≤1, 0≤y≤1), and LiₓCoPO₄ (0<x≤1), and fluorinated iron sulfates (for example, LiₓFeSO₄F (0<x≤1)).

The positive electrode active material is contained in the positive electrode active material-containing portion in a form of, for example, particles. The positive electrode active material particles may be single primary particles, secondary particles as aggregates of the primary particles, or a mixture of the primary particles and the secondary particles. The shape of the particle is not particularly limited, and can be, for example, a spherical shape, an elliptical shape, a flat shape, a fibrous shape, or the like.

The average particle size (diameter) of the primary particles of the positive electrode active material is preferably 1 μm or less and more preferably 0.01 μm or more and 0.1 μm or less. The average particle size (diameter) of the secondary particles of the positive electrode active material is preferably 10 μm or less and more preferably 1 μm or more and 5 μm or less.

### <Binder>

A binder has an action of binding the active material and the current collector. The binder is blended to fill a gap between dispersed active materials and bind the active material and the current collector. Examples of the binder include polytetrafluoro ethylene (PTFE), polyvinylidene fluoride (PVdF), a fluorine-based rubber, a styrene butadiene rubber, a polyacrylic acid compound, an imide compound, carboxymethyl cellulose (CMC), and a salt of CMC. One of these may be used as the binder, or a combination of two or more thereof may be used as the binder.

As the binder, particularly, polyvinylidene fluoride, which is excellent in binding properties, is desirable. A styrene-butadiene rubber is also desirable as the binder. Since the styrene-butadiene rubber is an emulsion and is easily impregnated into the electrolyte, the styrene-butadiene rubber can be easily impregnated into the current collector.

### <Conductive Agent>

The conductive agent is blended as necessary in order to enhance current collection performance and suppress contact resistance between the active material and the current collector.

Examples of the conductive agent include carbonaceous substances such as acetylene black, Ketjen black, graphite, and coke. The conductive agent may be one kind, or two or more kinds thereof may be used as a mixture.

### <Blending Ratio of Active Material, Conductive Agent, and Binder>

A blending ratio of the active material, the conductive agent, and the binder in the active material-containing portion can be appropriately changed. For example, it is preferable to blend the active material, the conductive agent, and the binder in proportions of 40% by weight or more and 96% by weight or less, 2% by weight or more and 30% by weight or less, and 2% by weight or more and 30% by weight or less, respectively. When the amount of the conductive agent is 2% by weight or more, the current collecting performance of the active material-containing portion can be improved. When the amount of the binder is 2% by weight or more, binding properties between the active material-containing portion and the current collector becomes sufficient, and excellent cycle performance can be expected. On the other hand, the content of each of the conductive agent and the binder is preferably 30% by weight or less in order to increase the capacity.

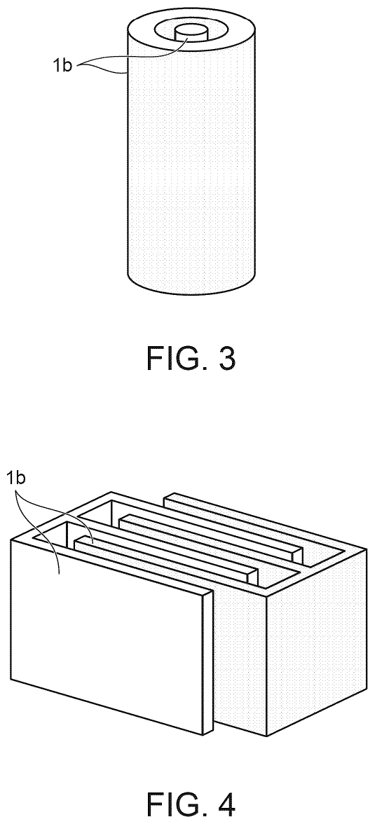

The electrode of the embodiment is not limited to the sheet shape, and may be shaped so as to have a three-dimensional structure. By using the electrode according to the embodiment for both the negative electrode and the positive electrode, for example, the negative electrode and the positive electrode can have a shape as illustrated in FIG. 3 and FIG. 4. In FIG. 3, one electrode has a cylindrical shape with a cavity, and the other electrode exists in the cavity of the one electrode and has a concentric circular structure. In FIG. 4, the electrode has a comb-teeth structure, and a convex portion and a concave portion of one electrode and the other electrode are arranged each other.

### <Various Measurement Methods>

Hereinafter, confirmation of the composition of the current collector, measurement of the first porosity, and measurement of the second porosity will be described.

When the electrode of the embodiment is included in a battery, the battery is disassembled, and a part of the electrode is cut out. As a method, a battery in a fully discharged state (state of charge (SOC) 0%) is disassembled in a glove box filled with argon. At a central portion of the taken-out electrode, for example, the electrode is cut into a size of 2 cm×2 cm, and this is used as a sample. As a cutting method, for example, cutting into a desired size can be performed with a water jet cutter. By using this, even a metal material can be cut without abrasion heat. Note that, the sample to be used for measurement is cut into a smaller size and measured when there is a measurement restriction. As a solvent used thereafter, pure water is selected if the electrolyte contained in the electrode is an aqueous electrolyte. In a case of a nonaqueous electrolyte, an N-methylpyrrolidone (NMP) solvent is selected.

### <Confirmation of Composition of Current Collector>

When the current collector contains a metal, the elemental composition of the metal can be determined by an inductively coupled plasma (ICP) emission spectroscopy.

The cut sample is immersed in pure water or an NMP solvent, and subjected to ultrasonic cleaning at 45° C. for 1 hour. Then, the sample is taken out, and the same treatment is repeated twice in new pure water or an NMP solvent. Then, the sample is shaken in new pure water or NMP solvent for 10 seconds and dried at 120° C. for 3 hours. As a result, it is possible to obtain a current collector obtained by removing deposits from the electrode. The obtained current collector is subjected to ICP measurement.

### <Measurement of First Porosity>

The measuring of first porosity can be confirmed by performing an observation with a scanning electron microscope (SEM) with respect to a cross section of the current collector.

As a method, after a current collector is obtained in the same manner as in the confirmation of the composition of the current collector, a cut surface in a thickness direction is cut out by using a focused ion beam (FIB), and SEM observation is performed. Then, cross-sectional processing in the same direction by the FIB and the observation by the SEM are repeated. An FIB processing pitch can take any value, but for example, the FIB processing pitch can be approximately 150 nm, and the number of repetitions of FIB processing and SEM observation can be 100 times. As a result, SEM observation images of continuous cross-sections are obtained.

By using energy dispersive X-ray spectroscopy (EDX) at the time of the SEM observation, a distribution of the current collector in the acquired SEM cross-sectional image can be quantified by mapping. When the metal element is confirmed by the above-described method, a mapping image of a corresponding metal element is binarized by image analysis, and a ratio of an area of the void portion (other than the current collector) to a total area of the image can be calculated. When no metal element is confirmed, a contrast difference between the current collector and a covering portion other than the current collector is increased, and image analysis is performed in a state in which a difference between the current collector and the covering portion is clarified. This is performed on all SEM cross-sectional images obtained by FIB processing. The SEM cross-sectional image is preferably observed at a magnification at which (1) a void portion and a metal portion in the current collector can be clearly distinguished, and (2) a portion having local unevenness in porosity can be sufficiently averaged. For example, by performing observation in a field of view of 10 or more times and 50 or less times an average void size in the current collector observed in the cross-sectional SEM, the measurement can be performed under a condition in which (1) and (2) are compatible. The FIB processing pitch at the time of performing cross-sectional processing at constant intervals by FIB processing is preferably set at a pitch of 1/10 or less, for example approximately 1/100 of the average void size for accurate observation. In addition, with regard to the number of repetitions of the FIB, a three-dimensional structure can be well reproduced by setting a depth of the current collector that can be reproduced at the time of superposition to 10 or more times and 50 or less times the average void size. For example, in a case of a current collector having an average void size of 2 μm in the cross-sectional SEM, observation is performed in a measurement field of view of vertical and horizontal sides of 20 μm or more and 100 μm or less in one field of view. In addition, the FIB processing is repeatedly performed with a FIB processing pitch (constant width) of 20 nm or more and 200 nm or less. The three-dimensional structure of the current collector can be well reproduced by performing the number of repetition corresponding to reproducing a depth of 20 μm or more and 100 μm or less. The porosity of the three-dimensional structure can be calculated by calculating the porosity obtained by image analysis for all of the acquired images and acquiring the average thereof. According to this, the first porosity can be measured. In addition, from the obtained analysis result, it is possible to visualize a path that can advance from any void to an opposite surface through a continuous void in a depth direction of the current collector. When a movement length of the path is set as f and the thickness in the depth direction is set as s, a curved path ratio r can be calculated. (r=f/s) An average of all void paths is expressed as the average curved path ratio.

### <Measurement of Second Porosity>

The measurement of the second porosity can be confirmed by acquiring a pore distribution by mercury porosimetry using an electrode. As a measuring device of the mercury porosimetry, for example, AutoPore 9520 manufactured by Shimadzu Corporation can be used.

The cut sample is washed with pure water or an NMP solvent. When cleaning of the electrode after being taken out from the battery is insufficient, the second porosity may be difficult to observe due to an influence of a lithium salt (for example, lithium fluoride) remaining in the electrode. The pore diameter is determined from the pore size distribution obtained by the mercury intrusion method. The analysis principle of the mercury intrusion method is based on Washburn's equation (A).

$$D = - 4 γ cos θ / P \qquad Equation ( A )$$

Here, P is an applied pressure, D is a pore diameter, γ is a surface tension of mercury (480 dyne·cm⁻¹), and θ is 140° in terms of a contact angle between mercury and a pore wall surface. Since γ and θ are constants, a relationship between the applied pressure P and the pore diameter D is obtained from the Washburn's equation, and the pore diameter and a volume distribution thereof can be derived by measuring a mercury intrusion volume at that time. From the obtained pore diameter and the sum of the abundance, the porosity of the sample can be quantified.

### <Manufacturing Method>

The electrode according to the embodiment can be manufactured, for example, as follows. First, slurry in which a positive electrode active material or a negative electrode active material is dispersed in a solvent is prepared. A porous current collector is impregnated with the slurry, and is taken out after being left to stand under reduced pressure. Thereafter, a surface is wiped and dried. As a result, an electrode in which the active material is supported on an inner surface of the porous current collector can be prepared. At this time, the viscosity of the slurry is preferably 1 mPa·s or more and less than 10 mPa·s. When the viscosity is less than 1 mPa·s, the active material is likely to settle in the slurry, and it becomes difficult to obtain a uniform electrode. On the other hand, when the viscosity is 10 mPa·s or more, the slurry is hardly impregnated into the porous current collector, and a sufficient amount of active material cannot be supported on the current collector. The pressure reduction during impregnation is preferably large enough to prevent volatilization of the solvent used in the slurry. When the pressure is reduced to −80 kPa or more and −50 kPa or less in a case of N-methylpyrrolidone (NMP), and to −60 kPa or more and −40 kPa or less in a case of a water solvent, the slurry can be impregnated into the porous current collector without excessively volatilizing the solvent.

The electrode according to the first embodiment includes the current collector and the active material-containing portion. In the current collector, the first porosity of the current collector is 70% or more and 90% or less. The second porosity of the electrode is 60% or more and 80% or less. The active material-containing portion is supported on the current collector. With such a configuration, it is possible to provide an electrode which is excellent in charge and discharge performance and can realize a high-capacity secondary battery.

### Second Embodiment

According to a second embodiment, a secondary battery including a negative electrode, a positive electrode, and an electrolyte is provided. The secondary battery includes the electrode according to the embodiment. At least one of the negative electrode and the positive electrode is the electrode according to the first embodiment. In a case where either the negative electrode or the positive electrode is the electrode according to the first embodiment, a counter electrode may have a configuration different from that in the first embodiment.

The secondary battery according to the second embodiment can further include a separator between the positive electrode and the negative electrode. The negative electrode, the positive electrode, and the separator may constitute an electrode group. The electrolyte can be retained in the electrode group.

In addition, the secondary battery according to the second embodiment may further include an exterior package member housing the electrode group and the electrolyte.

The secondary battery according to the second embodiment can further include a negative electrode terminal electrically connected to the negative electrode and a positive electrode terminal electrically connected to the positive electrode.

The secondary battery according to the second embodiment can be, for example, an aqueous lithium battery.

Furthermore, the secondary battery according to the second embodiment may be, for example, a lithium ion secondary battery. The secondary battery includes a nonaqueous electrolyte secondary battery containing a nonaqueous electrolyte.

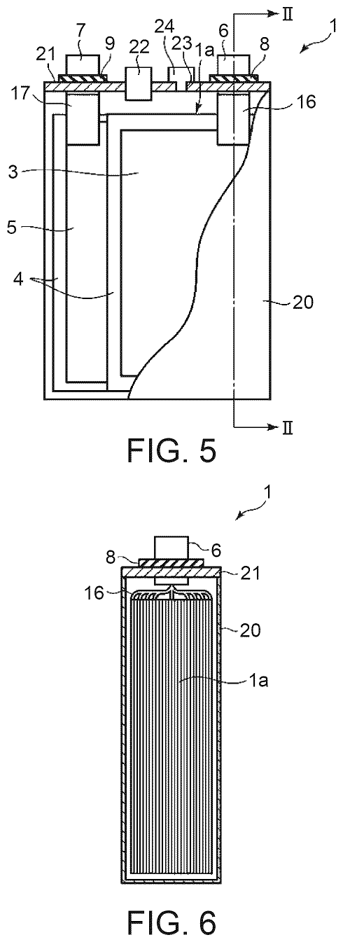

An example in which the battery of the embodiment is applied to a secondary battery will be described with reference to FIG. 5 to FIG. 8.

The secondary battery 1 includes an electrode group 1a and an exterior package member 20 in which the electrode group 1a is housed. An electrode group 1a is stored in the exterior package member 20 made of a rectangular tubular metal container. The electrode group 1a includes a negative electrode 3, a separator 4, and a positive electrode 5. The electrode group 1a has a structure in which the separator 4 is interposed between the positive electrode 5 and the negative electrode 3 and is spirally wound so as to have a flat shape. An aqueous electrolyte (not illustrated) is held in the electrode group 1a. As illustrated in FIG. 6, a negative electrode lead 16 having a strip shape is electrically connected to each of a plurality of portions at an end of the negative electrode 3 located on an end face of the electrode group 1a. In addition, a positive electrode lead 17 having a strip shape is electrically connected to each of a plurality of portions at an end of the positive electrode 5 located on an end surface. A plurality of the negative electrode leads 16 are connected to the negative electrode terminal 6 in a bundled state as illustrated in FIG. 6. Although not illustrated in the drawing, a plurality of the positive electrode leads 17 are also electrically connected to the positive electrode terminal 7 in a bundled state, similarly.

A sealing plate 21 made of a metal is fixed to an opening portion of the exterior package member 20 made of a metal by welding or the like. The negative electrode terminal 6 and the positive electrode terminal 7 are extracted to the outside from take-out holes provided in the sealing plate 21, respectively. On an inner peripheral surface of each of the take-out holes of the sealing plate 21, each of a negative electrode gasket 8 and a positive electrode gasket 9 is disposed to avoid a short circuit caused by contact between the negative electrode terminal 6 and the positive electrode terminal 7. By disposing the negative electrode gasket 8 and the positive electrode gasket 9, airtightness of a secondary battery 100 can be maintained.

A control valve 22 (safety valve) is disposed in the sealing plate 21. When the internal pressure in the battery cell increases due to the gas generated in the exterior package member 20, the generated gas can be diffused to the outside from a control valve 22. As the control valve 22, for example, a return type valve that operates when the internal pressure exceeds a set value and functions as a sealing plug when the internal pressure lowers can be used. Alternatively, a non-return type control valve that cannot recover the function as a sealing plug once it operates may be used. In FIG. 5, the control valve 22 is disposed at the center of the sealing plate 21, but the position of the control valve 22 may be an end of the sealing plate 21. Note that, the control valve 22 may be omitted.

In addition, the sealing plate 21 is provided with a liquid injection port 23. The electrolyte may be injected via the liquid injection port 23. The liquid injection port 23 may be closed by a sealing plug 24 after the electrolyte is injected. The liquid injection port 23 and the sealing plug 24 may be omitted.

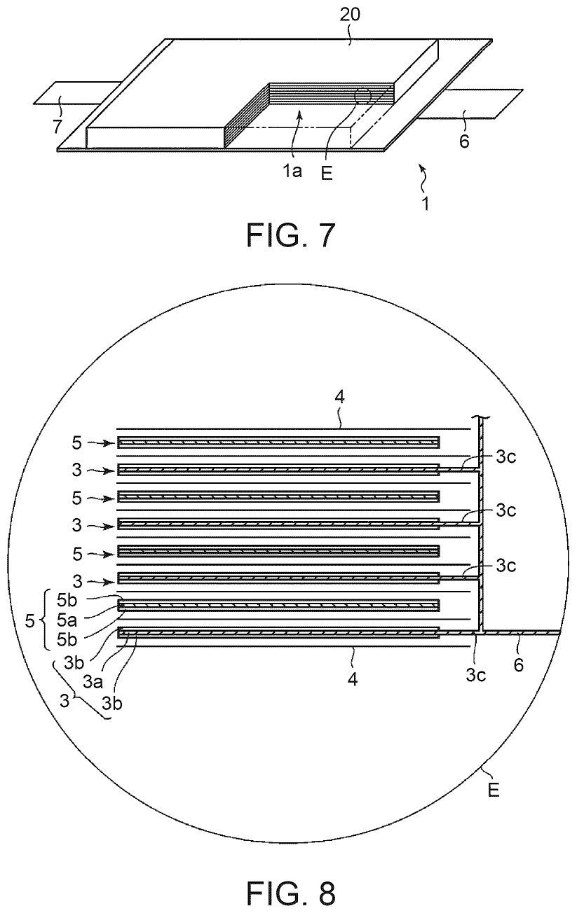

Another example of the secondary battery will be described with reference to FIG. 7 and FIG. 8. FIG. 7 and FIG. 8 illustrate an example of the secondary battery 1 using an exterior package member made of a laminate film as a container.

The secondary battery 1 illustrated in FIG. 7 and FIG. 8 includes the electrode group 1a illustrated in FIG. 7 and FIG. 8, the exterior package member 20 illustrated in FIG. 7, and an electrolyte (not illustrated). The electrode group 1a and the electrolyte are housed in the exterior package member 20. The electrolyte is retained in the electrode group 1a.

The exterior package member 20 includes a laminate film in which a metal layer is interposed between two resin layers.

As illustrated in FIG. 8, the electrode group 1a is a stacked electrode group. The stacked electrode group 1a has a structure in which the negative electrode 3 and the positive electrode 5 are alternately stacked with the separator 4 interposed therebetween.

The electrode group 1a includes a plurality of the negative electrodes 3. Each of the plurality of negative electrodes 3 includes a negative electrode current collector 3a, and a negative electrode active material-containing layer 3b supported on both surfaces (for example, both main surfaces) of the negative electrode current collector 3a. The electrode group 1a includes a plurality of the positive electrodes 5. Each of the plurality of the positive electrodes 5 includes a positive electrode current collector 5a and a positive electrode active material-containing layer 5b supported on both surfaces (a first surface and a second surface) of the positive electrode current collector 5a.

The negative electrode current collector 3a of each of the negative electrodes 3 includes a portion 3c in which the negative electrode active material-containing layer 3b is not supported even on any surface at one side. The portion 3c serves as a negative electrode current collector tab. As illustrated in FIG. 8, the portion 3c serving as a negative electrode current collector tab does not overlap the positive electrode 5. A plurality of the negative electrode current collector tabs (portions 3c) are electrically connected to the negative electrode terminal 6 having a strip shape. A leading end of the negative electrode terminal 6 having a strip shape is drawn to the outside from the exterior package member 20.

Although not illustrated, the positive electrode current collector 5a of each of the positive electrodes 5 includes a portion where the positive electrode active material-containing layer 5b is not supported on any surface at one side. The portion serves as a positive electrode current collector tab. The positive electrode current collector tab does not overlap the negative electrode 3 similarly to the negative electrode current collector tab (portion 3c). The positive electrode current collector tab is located on an opposite side of the electrode group 1a with respect to the negative electrode current collector tab (portion 3c). The positive electrode current collector tab is electrically connected to the positive electrode terminal 7 having a strip shape. A leading end of the positive electrode terminal 7 having a strip shape is located on a side opposite to the negative electrode terminal 6 and is drawn to the outside of the exterior package member 20.

Hereinafter, the counter electrode, the electrolyte, the separator, the exterior package member, the negative electrode terminal, and the positive electrode terminal will be described in detail.

### 1) Counter Electrode

The counter electrode may include a current collector, and an active material-containing layer. The active material-containing layer may be supported on one surface of the current collector, or may be supported on both surfaces thereof. The active material-containing layer may contain an active material, a conductive agent, and a binder. The active material-containing layer may contain or may not contain fibrous carbon. The counter electrode is a negative electrode in a case where the electrode according to the embodiment is a positive electrode, and is a positive electrode in a case where the electrode according to the embodiment is a negative electrode. Here, description will be made on the assumption that the counter electrode is the positive electrode.

The positive electrode current collector can be formed from, for example, a material that is electrochemically stable at a potential at which lithium (Li) is inserted into and extracted from the active material. Examples of the positive electrode current collector include a conductive sheet containing a conductive material and a polymer material, a conductive sheet containing at least one kind of metal element selected from the group consisting of Pb, Bi, Zn, Sb, and Sn, metal foil such as copper, nickel, stainless steel, or aluminum, and aluminum alloy foil containing one or more elements selected from Mg, Ti, Zn, Mn, Fe, Cu, and Si. As the polymer material of the conductive sheet, polyethylene, polypropylene, polyethylene terephthalate, polyacrylonitrile, polymethyl methacrylate, and polyvinylidene fluoride can be used. As the conductive material, a conductive filler such as a carbonaceous material is preferably used. Examples of the carbonaceous material include carbon black, Ketjen black, graphite, fibrous carbon, and carbon nanotube. The kind of each of the conductive material and the polymer material can be one kind or two or more kinds.

As the positive electrode active material, a compound having a lithium ion absorption and release potential of 3 V (vs. Li/Li⁺) or more and 5.5 V (vs. Li/Li⁺) or less as a potential based on metal lithium can be used. The positive electrode may contain one kind of positive electrode active material, or may contain two or more kinds of positive electrode active materials.

Examples of the positive electrode active material include a lithium-manganese composite oxide, a lithium-nickel composite oxide, a lithium-cobalt-aluminum composite oxide, a lithium-nickel-cobalt-manganese composite oxide, a spinel type lithium-manganese-nickel composite oxide, a lithium-manganese-cobalt composite oxide, a lithium-iron oxide, a lithium fluorinated iron sulfate, and a phosphate compound having an olivine crystal structure (for example, LiₓFePO₄ (0<x≤1) and LiₓMnPO₄ (0<x≤1)). The phosphate compound having an olivine crystal structure is excellent in thermal stability.

Examples of positive active materials from which a high positive electrode potential can be obtained include lithium-nickel-cobalt-manganese composite oxides (LiₓNi_{1-y-z}Co_{y}Mn_{z}O₂; 0<x≤1, 0<y<1, 0<z<1, y+z<1), lithium-manganese composite oxides such as LiₓMn₂O₄ (0<x≤1), LiₓMnO₂ (0<x≤1) having a spinel structure, lithium-nickel-aluminum composite oxides such as LiₓNi_{1-y}Al_{y}O₂ (0<x≤1, 0<y<1), lithium-cobalt composite oxides such as LiₓCoO₂ (0<x≤1), lithium-nickel-cobalt composite oxides such as LiₓNi_{1-y-z}CO_{y}Mn₂O₂ (0<x≤1, 0<y<1, 0≤z<1), lithium-manganese-cobalt composite oxides such as LiₓMn_{y}Co_{1-y}O₂ (0<x≤1, 0<y<1), spinel-type lithium-manganese-nickel composite oxides such as LiₓMn_{1-y}Ni_{y}O₄ (0<x≤1, 0<y<2, 0<1−y<1), lithium phosphorus oxides having an olivine structure such as LiₓFePO₄ (0<x≤1), LiₓFe_{1-y}Mn_{y}PO₄ (0<x≤1, 0≤y≤1), and LiₓCoPO₄ (0<x≤1), and fluorinated iron sulfates (for example, LiₓFeSO₄F (0<x≤1)).

The positive electrode active material is contained in the positive electrode in a form of, for example, particles. The positive electrode active material particles may be single primary particles, secondary particles as aggregates of the primary particles, or a mixture of the primary particles and the secondary particles. The shape of the particle is not particularly limited, and can be, for example, a spherical shape, an elliptical shape, a flat shape, a fibrous shape, or the like.

The average particle size (diameter) of the primary particles of the positive electrode active material is preferably 1 μm or less and more preferably 0.01 μm or more and 0.1 μm or less. The average particle size (diameter) of the secondary particles of the positive electrode active material is preferably 10 μm or less and more preferably 1 μm or more and 5 μm or less.

The positive electrode active material-containing layer may contain a binder. A binder has an action of binding the active material and the current collector. The binder is blended to fill a gap between dispersed active materials and bind the active material and the current collector. Examples of the binder include polytetrafluoro ethylene (PTFE), polyvinylidene fluoride (PVdF), a fluorine-based rubber, a styrene butadiene rubber, a polyacrylic acid compound, an imide compound, carboxymethyl cellulose (CMC), and a salt of CMC. One of these may be used as the binder, or a combination of two or more thereof may be used as the binder.

The positive electrode active material-containing layer may contain a conductive agent and the like in addition to the positive electrode active material and the binder. The conductive agent is blended as necessary in order to enhance current collection performance and suppress contact resistance between the active material and the current collector.

Examples of the conductive agent include carbonaceous substances such as acetylene black, Ketjen black, graphite, and coke. The conductive agent may be one kind, or two or more kinds thereof may be used as a mixture.

In the positive electrode active material-containing layer, it is preferable that each of the positive electrode active material and the binder is blended at a ratio of 80% by weight or more and 98% by weight or less, and 2% by weight or more and 20% by weight or less.

By setting the amount of binder to 2% by weight or more, it is possible to obtain a sufficient electrode strength. In addition, the binder may function as an insulating body. Therefore, in a case where the amount of binder is 20% by weight or less, the amount of the insulating body contained in the electrode decreases, and thus it is possible to reduce internal resistance.

In a case of adding the conductive agent, it is preferable that each of the positive electrode active material, the binder, and the conductive agent is blended at a ratio of 65% by weight or more and 95% by weight or less, 2% by weight or more and 20% by weight or less, and 3% by weight or more and 15% by weight or less.

By setting the amount of conductive agent to 3% by weight or more, it is possible to obtain the effects described above. In addition, by setting the amount of conductive agent to 15% by weight or less, it is possible to reduce a ratio of the conductive agent in contact with the electrolyte. In a case where such a ratio is low, it is possible to reduce decomposition of the electrolyte in high-temperature storage.

### 2) Electrolyte

The electrolyte of the secondary battery according to the embodiment may be an electrolyte containing water or a nonaqueous electrolyte. The electrolyte may have a high viscosity or may be 200 mPa·s or more, but is desirably 10000 mPa·s or less. When the electrolyte has a viscosity in a desired range, the second porosity is 60% or more and 80% or less, and thus the inside of the electrode can be impregnated with the electrolyte.

Here, description will be made on the assumption that the electrolyte is an electrolyte containing water. Hereinafter, the electrolyte containing water may be referred to as an aqueous electrolyte.

The aqueous electrolyte contains an aqueous solvent and an electrolyte salt dissolved in the aqueous solvent. The aqueous electrolyte may be in a liquid state or a gel state. A liquid aqueous electrolyte is, for example, an aqueous solution prepared by dissolving the electrolyte salt serving as a solute in the aqueous solvent. The gel-like aqueous electrolyte is prepared, for example, by mixing a liquid aqueous electrolyte and a polymer compound to form a composite. Examples of the polymer compound include polyvinylidene fluoride (PVdF), polyacrylonitrile (PAN), and polyethylene oxide (PEO). When the aqueous electrolytes are held in both of the negative electrode active material-containing layer and the positive electrode active material-containing layer, the kinds of these aqueous electrolytes may be the same as or different from each other.

The aqueous solution preferably has an aqueous solvent amount of 1 mol or more and more preferably an aqueous solvent amount of 3.5 mol or more with respect to 1 mol of salt serving as a solute.

As the aqueous solvent, a solution containing water can be used. The solution containing water may be pure water or a mixed solvent of water and an organic solvent. The aqueous solvent contains, for example, water at a ratio of 50 vol % or more.

As the electrolyte salt, for example, a lithium salt, a sodium salt, or a mixture thereof can be used. One kind or two or more kinds of electrolyte salts can be used.

Examples of the lithium salt include lithium chloride (LiCl), lithium bromide (LiBr), lithium hydroxide (LiOH), lithium sulfate (LizSO₄), lithium nitrate (LiNO₃), lithium acetate (CH₃COOLi), lithium oxalate (Li₂C₂O₄), lithium carbonate (Li₂CO₃), lithium difluoroxalatoborate (LiDFOB, C₂BF₂LiO₄), lithium bis(trifluoromethanesulfonyl) imide (LiTFSI; LiN (CF₃SO₂)₂), lithium bis(fluorosulfonyl) imide (LiFSI; LiN (FSO₂)₂), lithium bis(pentafluoroethanesulfonyl) imide (LiBETI; LiN (SO₂C₂F₅)₂), lithium bisoxalate borate (LiBOB: LiB[(OCO)_{2]2}), and the like can be used.

The lithium salt preferably contains at least one selected from the group consisting of LiN(FSO₂)₂, LiN (CF₃SO₂)₂, and LiN(SO₂C₂F₅)₂. Each lithium salt is solid at a temperature near a room temperature, but can be changed to a liquid state by a eutectic reaction with a compound containing an amide bond. Therefore, it is possible to contribute to reduction of a water content in the aqueous electrolyte. A lithium salt containing LiTFSI; LiN(CF₃SO₂)₂ is desirable.

As the sodium salt, sodium chloride (NaCl), sodium sulfate (Na₂SO₄), sodium hydroxide (NaOH), sodium nitrate (NaNO₃), sodium trifluoromethanesulfonyl amide (NaTFSA), and the like can be used.

The aqueous electrolyte preferably contains, as anion species, at least one or more kinds selected from a chloride ion (Cl⁻), a hydroxide ion (OH⁻), a sulfate ion (SO₄²⁻), and a nitrate ion (NO₃⁻).

The aqueous electrolyte may contain a compound containing an amide bond. According to this, electrolysis of water can be suppressed, and thus charge and discharge performance can be improved. The compound containing an amide bond can form a liquid mixture by a eutectic reaction with a lithium salt consisting of at least one selected from the group consisting of LiTFSI, LiFSI, and LiBETI. Therefore, an aqueous electrolyte containing a compound containing an amide bond and a lithium salt consisting of at least one selected from the group consisting of LiTFSI, LiFSI, and LiBETI can have a desired lithium ion concentration even when the amount of the aqueous solvent is small. Therefore, it is possible to suppress electrolysis of water without impairing ion conductivity of the aqueous electrolyte.

Examples of the compound containing an amide bond include compounds similar to those described for the negative electrode. The kind of the compound containing an amide bond may be one kind or two or more kinds.

The content of the compound containing an amide bond in the aqueous electrolyte can be 30% by weight or more and 55% by weight or less. A more preferable range is 30% by weight or more and 45% by weight or less. Within the above range, a nitrogen-containing compound film can be formed on the surface of negative electrode active material particles. In addition, the lithium salt can be present in a liquid state even when the amount of the aqueous solvent in the aqueous electrolyte is small.

The aqueous electrolyte may contain potassium hydroxide (KOH). The potassium hydroxide can function as a catalyst for a reaction for forming a film on the surface of the negative electrode active material particles. Therefore, when the aqueous s electrolyte contains the compound containing an amide bond and potassium hydroxide, the formation of the nitrogen-containing compound film on the surface of the negative electrode active material particles can be promoted.

A pH of the aqueous electrolyte is preferably 3 or more and 14 or less, and more preferably 4 or more and 13 or less. When a different electrolyte is used in each of a negative electrode side electrolyte and a positive electrode side electrolyte, the pH of the negative electrode side electrolyte is preferably within a range of 3 or more and 14 or less, and the pH of the positive electrode side electrolyte is preferably within a range of 1 or more and 8 or less.

When the pH of the negative electrode side electrolyte is within the above-described range, since a hydrogen generation potential in the negative electrode lowers, hydrogen generation in the negative electrode is suppressed. Thereby, the storage performance and cycle life performance of the battery are improved. When the pH of the positive electrode side electrolyte is within the above-described range, since an oxygen generation potential in the positive electrode increases, oxygen generation in the positive electrode decreases. Thereby, the storage performance and cycle life performance of the battery are improved. The pH of the positive electrode side electrolyte is more preferably within a range of 3 or more and 7.5 or less.

The aqueous electrolyte may contain a surfactant. Examples of the surfactant include non-ionic surfactants such as polyoxyalkylene alkyl ether, polyethylene glycol, polyvinyl alcohol, thiourea, disodium 3,3′-dithiobis(1-propanephosphate), dimercaptothiadiazole, boric acid, oxalic acid, malonic acid, saccharin, sodium naphthalene sulfonate, gelatin, potassium nitrate, aromatic aldehyde, and heterocyclic aldehyde. The surfactant may be used alone or two or more kinds thereof can be used as a mixture.

### 3) Separator

The separator is disposed, for example, between the positive electrode and the negative electrode. The separator may include a separator covering only one of the positive electrode and the negative electrode.

The separator can have a porous structure. Examples of the porous separator include a nonwoven fabric, a film, and paper. Examples of the constituent material of the porous separator constituting the nonwoven fabric, the film, the paper, and the like include polyolefins such as polyethylene and polypropylene, and cellulose. Preferable examples of the porous separator include a nonwoven fabric containing cellulose fibers and a porous film containing polyolefin fibers.

The porosity of the porous separator is preferably 60% or more. A fiber diameter is preferably 10 μm or less. When the fiber diameter is 10 μm or less, the affinity of the porous separator for the electrolyte is improved, and thus the battery resistance can be reduced. The fiber diameter is more preferably 3 μm or less. A cellulose fiber-containing nonwoven fabric having a porosity of 60% or more has satisfactory electrolyte impregnation properties, and can exhibit high output performance from a low temperature to a high temperature. A more preferable range of the porosity is 62% to 80%.

The porous separator preferably has a thickness of 20 μm or more and 100 μm or less and a density of 0.2 g/cm³ or more and 0.9 g/cm³ or less. Within this range, mechanical strength and reduction of battery resistance can be balanced, and a secondary battery having high output and suppressed internal short circuit can be provided. In addition, the thermal shrinkage of the separator in a high-temperature environment is small, and satisfactory high-temperature storage performance can be achieved.

As the separator, a composite separator including a porous separator and a layer formed on one side or both sides of the porous separator and containing inorganic particles may be used. Examples of the inorganic particles include aluminum oxide and silicon oxide.

A solid electrolyte layer may be used as the separator. The solid electrolyte layer may contain solid electrolyte particles and a polymer component. The solid electrolyte layer may be composed of only solid electrolyte particles. The solid electrolyte layer may contain one kind of solid electrolyte particles or may contain a plurality of kinds of solid electrolyte particles. The solid electrolyte layer may contain at least one selected from the group consisting of a plasticizer and an electrolyte salt. When the solid electrolyte layer contains an electrolyte salt, for example, alkali metal ion conductivity of the solid electrolyte layer can be further enhanced. A form of the polymer material may be, for example, a granular shape or a fibrous shape.

Preferably, the solid electrolyte layer has a sheet shape and includes few or no pores such as pinholes. The thickness of the solid electrolyte layer is not particularly limited, but is, for example, 150 μm or less, and preferably in the range of 20 μm or more and 50 μm or less.

The polymer component used in the solid electrolyte layer is desirably a polymer component insoluble in an aqueous solvent. Examples of the polymer component satisfying this condition include polyethylene terephthalate (PET), polypropylene (PP), polyethylene (PE), and a fluorine-containing polymer component. By using the fluorine-containing polymer component, water repellency can be imparted to the separator. In addition, the inorganic solid electrolyte has high stability to water and excellent lithium ion conductivity. By forming a composite of the inorganic solid electrolyte having lithium ion conductivity and the fluorine-containing polymer component, a solid electrolyte layer having alkali metal ion conductivity and flexibility can be realized. Since the separator including the solid electrolyte layer can reduce resistance, the large current performance of the secondary battery can be improved.

Examples of the fluorine-containing polymer component include polytetrafluoroethylene (PTFE), polychlorotrifluoroethylene (PCTFE), ethylene tetrafluoroethylene copolymer, polyvinylidene fluoride (PVdF), and the like. The kind of the fluorine-containing polymer component can be one kind or two or more kinds.

When the solid electrolyte layer contains a polymer component, a content ratio of the polymer component in the solid electrolyte layer is preferably 1% by weight or more and 20% by weight or less. Within this range, when the thickness of the solid electrolyte layer is in the range of 10 to 100 μm, high mechanical strength can be obtained, and resistance can be reduced. Furthermore, the solid electrolyte is less likely to be a factor of inhibiting lithium ion conductivity. A more preferable range of the ratio is 3% by weight or more and 10% by weight or less.

As the solid electrolyte, an inorganic solid electrolyte is preferably used. The inorganic solid electrolyte is a solid substance having Li ion conductivity. The term “having Li ion conductivity” as used herein means that lithium ion conductivity of 1×10⁻⁶ S/cm or more is exhibited at 25° C. Examples of the inorganic solid electrolyte include an oxide-based solid electrolyte and a sulfide-based solid electrolyte. Specific examples of the inorganic solid electrolyte are as follows.

As the oxide-based solid electrolyte, a lithium phosphate solid electrolyte having a NASICON (Sodium (Na) Super Ionic Conductor)-type structure and expressed by a general formula Li₁₊ₓMα₂(PO₄)₃ is preferably used. Ma in the general formula is, for example, one or more selected from the group consisting of titanium (Ti), germanium (Ge), strontium (Sr), zirconium (Zr), tin (Sn), aluminum (Al), and calcium (Ca). The subscript x is within a range of 0≤x≤2.

Specific examples of the lithium phosphate solid electrolyte having a NASICON-type structure include an LATP compound expressed by Li₁₊ₓAlₓTi₂₋ₓ(PO₄)₃ and satisfying a relationship of 0.1≤x≤0.5; a compound expressed by Li₁₊ₓAl_{y}Mβ_{2-y}(PO₄)₃ in which MB is one or more selected from the group consisting of Ti, Ge, Sr, Zr, Sn and Ca, and relationships of 0≤x≤1 and 0≤y≤1 are satisfied; a compound expressed by Li₁₊ₓAlₓGe₂₋ₓ(PO₄)₃ and satisfying a relationship of 0≤x≤2; a compound expressed by Li₁₊ₓAlₓZr₂₋ₓ(PO₄)₃ and satisfying a relationship of 0≤x≤2; a compound expressed by Li_{1+x+y}AlₓMγ₂₋ₓSi_{y}P_{3-y}O₁₂ in which My is one or more selected from the group consisting of Ti and Ge, and relationships of 0<x≤2, and 0≤y<3 are satisfied; and a compound expressed by Li₁₊₂ₓZr₁₋ₓCaₓ(PO₄)₃ and satisfying a relationship of 0≤x<1.

Other than the lithium phosphate solid electrolyte, examples of the oxide-based solid electrolyte include an amorphous LIPON compound expressed by LixPOyNz and satisfying a relationship of 2.6≤x≤3.5, 1.9≤y≤3.8, and 0.1≤z≤1.3 (for example, Li_{2.9}PO_{3.3}N_{0.46}); a compound expressed by La₅₊ₓAₓLa₃₋ₓMδ₂O₁₂ having a garnet type structure in which A is one or more selected from the group consisting of Ca, Sr, and Ba, Mo is one or more selected from the group consisting of Nb and Ta, and a relationship of 0≤x≤0.5 is satisfied; a compound expressed by Li₃Mδ₂₋ₓL₂O₁₂ in which Mδ is one or more selected from the group consisting of Nb and Ta, L may contain Zr, and a relationship of 0≤x≤0.5 is satisfied; a compound expressed by Li₇₋₃ₓAlₓLa₃Zr₃O₁₂ and satisfying a relationship of 0≤x≤0.5; an LLZ compound expressed by Li₅₊ₓLa₃Mδ₂₋ₓZrₓO₁₂ in which Mδ is one or more selected from the group consisting of Nb and Ta and a relationship of 0≤x≤2 is satisfied (for example, Li₇La₃Zr₂O₁₂); and a compound which has a perovskite-type structure, is expressed by La_{2/3-x}LiₓTiO₃ and satisfies a relationship of 0.3≤x≤0.7.

One or more of the above-described compounds can be used as a solid electrolyte. Two or more of the solid electrolytes may be used.

### 4) Exterior Package Member

At least the positive electrode, the negative electrode, the separator, and the aqueous electrolyte are housed in the exterior package member. As the exterior package member, for example, a metal container, a laminate film container, or a resin container can be used. As the metal container, a metal can that is made of nickel, iron, stainless steel, or the like and has a rectangular shape or a cylindrical shape can be used. As the resin container, a container made of polyethylene, polypropylene, or the like can be used.

The thickness of the laminate film, for example, is 0.5 mm or less, and preferably 0.2 mm or less.

As the laminate film, a multilayer film including a plurality of resin layers, and a metal layer interposed between the resin layers can be used. For example, the resin layer contains a polymeric material such as polypropylene (PP), polyethylene (PE), nylon, and polyethylene terephthalate (PET). It is preferable that the metal layer is made of an aluminum foil or an aluminum alloy foil for a reduction in weight. The laminate film is sealed by thermal fusion, and thus laminate film can be molded into the shape of an exterior package member.

The thickness of a wall of the metal container is, for example, 1 mm or less, more preferably 0.5 mm or less, and still more preferably 0.2 mm or less.

The metal container is made from, for example, aluminum, an aluminum alloy, or the like. It is preferable that the aluminum alloy contains an element such as magnesium, zinc, and silicon. If the aluminum alloy contains a transition metal such as iron, copper, nickel, or chromium, it is preferable that the content thereof is 100 ppm by mass or less.

The shape of the exterior package member is not particularly limited. The shape of the exterior package member may be, for example, a flat shape (a thin shape), a square shape, a cylindrical shape, a coin shape, a button shape, or the like. The exterior package member can be suitably selected in accordance with the size of the battery or the use of the battery.

The secondary battery according to the embodiment can be used in various forms such as a square shape, a cylindrical shape, a flat shape, a thin shape, and a coin shape. The secondary battery may be a secondary battery having a bipolar structure. For example, the electrode group may have a bipolar structure including a positive electrode active material-containing layer on one surface of one current collector and a negative electrode active material-containing layer on the other surface. In this case, there is an advantage that a plurality of cells in series can be manufactured by one cell.

### 5) Negative Electrode Terminal

The negative electrode terminal may contain a material that is electrochemically stable at a Li absorption and release potential of the negative electrode active material described above and has conductivity. Specifically, examples of the material of the negative electrode terminal include copper, nickel, stainless steel, aluminum, or an aluminum alloy containing at least one kind of element selected from the group consisting of Mg, Ti, Zn, Mn, Fe, Cu, and Si. It is preferable to use aluminum or an aluminum alloy as the material of the negative electrode terminal. It is preferable that the negative electrode terminal contains the same material as that of the negative electrode current collector in order to reduce the contact resistance with the negative electrode current collector.

### 6) Positive Electrode Terminal

The positive electrode terminal may contain a material that is electrically stable in a potential range (vs. Li/Li⁺) of 3 V or more and 4.5 V or less with respect to the oxidation and reduction potential of lithium and has conductivity. Examples of the material of the positive electrode terminal include aluminum, or an aluminum alloy containing at least one kind of element selected from the group consisting of Mg, Ti, Zn, Mn, Fe, Cu, and Si. The positive electrode terminal is preferably formed of the same material as that for the positive electrode current collector in order to reduce the contact resistance with the positive electrode current collector.

A secondary battery according to the embodiment includes the electrode according to the embodiment. Therefore, the secondary battery can have excellent life performance.

### Third Embodiment

According to a third embodiment, an assembled battery is provided. The assembled battery includes a plurality of the secondary batteries according to the embodiment.

In the assembled battery according to the embodiment, respective single batteries may be electrically arranged in series or in parallel or may be arranged in a combination of series connection and parallel connection.

Next, an example of the assembled battery will be described with reference to the drawings.

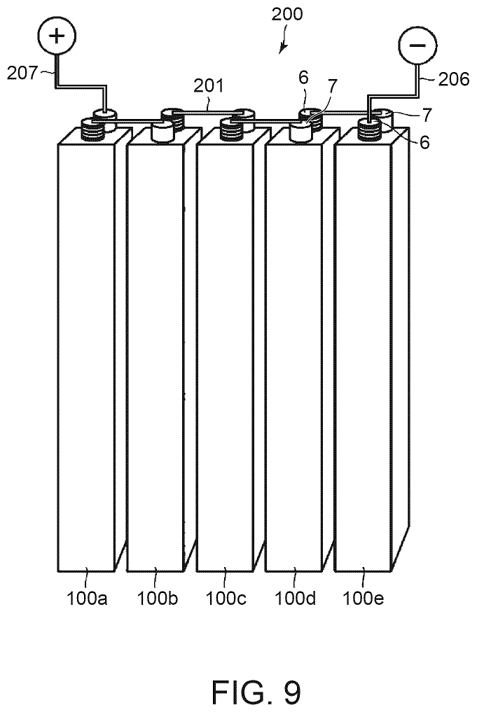

An assembled battery 200 illustrated in FIG. 9 includes five single batteries 100a to 100e, four bus bars 201, a positive electrode side lead 207, and a negative electrode side lead 206. Each of the five single batteries 100a to 100e is the secondary battery according to the embodiment.

For example, the bus bar 201 connects the negative electrode terminal 6 of one single battery 100a and the positive electrode terminal 7 of the adjacent single battery 100b. As described above, the five single batteries 100 are connected in series by the four bus bars 201. That is, the assembled battery 200 in FIG. 7 is a five-series assembled battery. Although an example is not illustrated, in an assembled battery including a plurality of single batteries electrically connected in parallel, for example, a plurality of negative electrode terminals are connected to each other by bus bars and a plurality of positive electrode terminals are connected to each other by bus bars, and thus the plurality of single batteries can be electrically connected.

The positive electrode terminal 7 of at least one battery among the five single batteries 100a to 100e is electrically connected to the positive electrode side lead 207 for external connection. In addition, the negative electrode terminal 6 of at least one battery among the five single batteries 100a to 100e is electrically connected to the negative electrode side lead 206 for external connection.

The assembled battery according to the embodiment includes the electrode according to the embodiment. Therefore, the assembled battery is excellent in charge and discharge performance and can realize a high capacity.

### Fourth Embodiment

According to a fourth embodiment, there is provided a battery pack including the secondary battery according to the embodiment. This battery pack can include the assembled battery according to the embodiment. The battery pack may include a single battery instead of the assembled battery according to the embodiment.

Such a battery pack can further include a protective circuit. The protective circuit has a function to control charge and discharge of the secondary battery. Alternatively, a circuit included in a device using a battery pack as a power supply (for example, an electronic device, an automobile, or the like) may be used as the protective circuit of the battery pack.

In addition, the battery pack can also further include an external power distribution terminal. The external power distribution terminal is configured to externally output current from the secondary battery and/or to input external current into the secondary battery. In other words, when the battery pack is used as a power supply, the current is supplied to the outside via the external power distribution terminal. When the battery pack is charged, a charging current (including regenerative energy of the power of an automobile or the like) is supplied to the battery pack via the external power distribution terminal.

Next, an example of the battery pack according to the embodiment will be described with reference to the drawings.

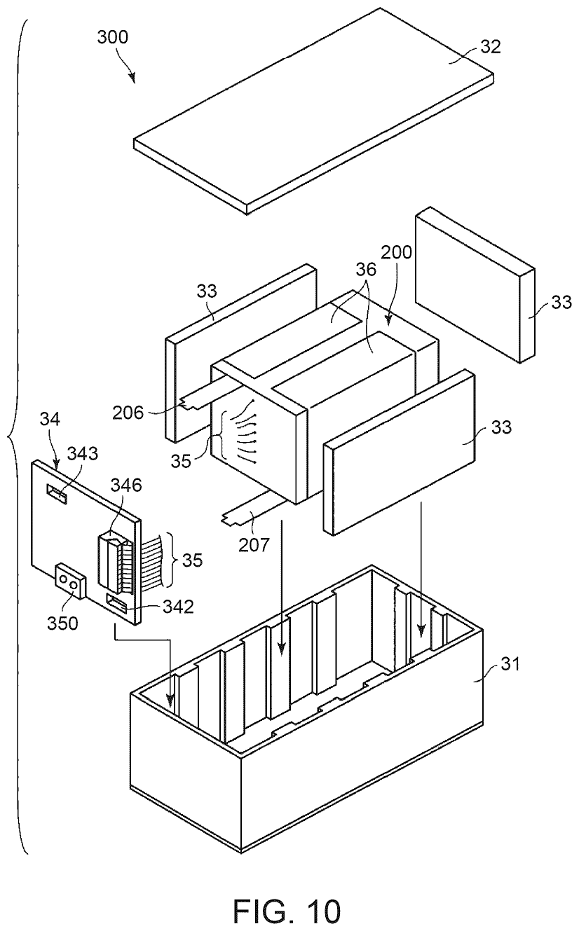

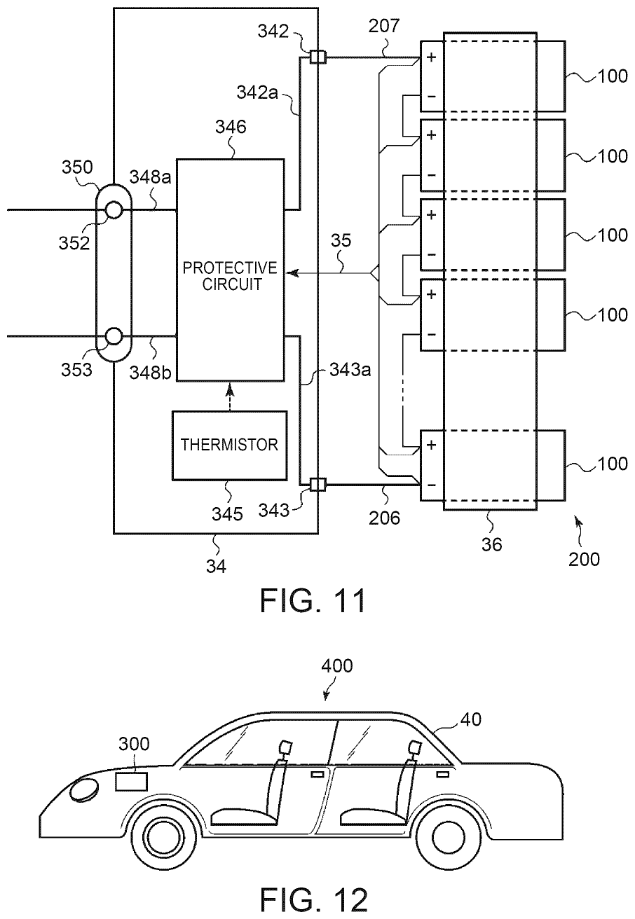

A battery pack 300 illustrated in FIG. 10 and FIG. 11 includes a housing container 31, a lid 32, protective sheets 33, the assembled battery 200, a printed wiring board 34, a wire 35, and an insulating plate (not illustrated).

The housing container 31 illustrated in FIG. 10 is a square bottomed container having a rectangular bottom surface. The housing container 31 is configured to be capable of housing the protective sheets 33, the assembled battery 200, the printed wiring board 34, and the wire 35. The lid 32 has a rectangular shape. The lid 32 covers the housing container 31 to house the assembled battery 200 and the like. The housing container 31 and the lid 32 are provided with opening portions, connection terminals, or the like (not illustrated) for connection to an external device or the like.

The assembled battery 200 includes a plurality of single batteries 100, a positive electrode side lead 207, a negative electrode side lead 206, and an adhesive tape 36.

At least one of the plurality of single batteries 100 is the secondary battery according to the embodiment. Each of the plurality of single batteries 100 is electrically connected in series as illustrated in FIG. 11. The plurality of single batteries 100 may be electrically connected in parallel or may be connected in a combination of series connection and parallel connection. When the plurality of single batteries 100 are connected in parallel, the battery capacity increases as compared with a case where the plurality of single batteries are connected in series.

The adhesive tape 36 fastens the plurality of single batteries 100. The plurality of single batteries 100 may be fixed using a heat-shrinkable tape instead of the adhesive tape 36. In this case, the protective sheets 33 are arranged on both side surfaces of the assembled battery 200, the heat-shrinkable tape is wound around, and the heat-shrinkable tape is shrunk by heating to bundle the plurality of single batteries 100.

One end of the positive electrode side lead 207 is connected to the assembled battery 200. The one end of the positive electrode side lead 207 is electrically connected to the positive electrode of one or more single batteries 100. One end of the negative electrode side lead 206 is connected to the assembled battery 200. The one end of the negative electrode side lead 206 is electrically connected to the negative electrode of one or more single batteries 100.

The printed wiring board 34 is installed along one of the inner surfaces of the housing container 31 in the short-side direction. The printed wiring board 34 includes a positive electrode side connector 342, a negative electrode side connector 343, a thermistor 345, a protective circuit 346, wires 342a and 343a, an external power distribution terminal 350, a plus-side wire (positive side wire) 348a, and a minus-side wire (negative side wire) 348b. One main surface of the printed wiring board 34 faces one side surface of the assembled battery 200. An insulating plate (not illustrated) is disposed between the printed wiring board 34 and the assembled battery 200.

The other end 207a of the positive electrode side lead 207 is electrically connected to the positive electrode side connector 342. The other end 206a of the negative electrode side lead 206 is electrically connected to the negative electrode side connector 343.

A thermistor 345 is fixed to one main surface of the printed wiring board 34. The thermistor 345 detects a temperature of each of the single batteries 100 and transmits a detection signal to the protective circuit 346.

The external power distribution terminal 350 is fixed to the other main surface of the printed wiring board 34. The external power distribution terminal 350 is electrically connected to a device that exists outside a battery pack 300. The external power distribution terminal 350 includes a positive side terminal 352 and a negative side terminal 353.

The protective circuit 346 is fixed to the other main surface of the printed wiring board 34. The protective circuit 346 is connected to the positive side terminal 352 via the plus-side wire 348a. The protective circuit 346 is connected to the negative side terminal 353 via the minus-side wire 348b. The protective circuit 346 is electrically connected to the positive electrode side connector 342 via the wire 342a. The protective circuit 346 is electrically connected to the negative electrode side connector 343 via the wire 343a. The protective circuit 346 is electrically connected to each of the plurality of single batteries 100 via the wires 35.

The protective sheets 33 are disposed on both inner surfaces of the housing container 31 along a long-side direction and on an inner surface thereof along a short-side direction facing the printed wiring board 34 across the assembled battery 200. The protective sheets 33 are made of, for example, a resin or rubber.

The protective circuit 346 controls charging and discharging of the plurality of single batteries 100. The protective circuit 346 is also configured to cut-off electric connection between the protective circuit 346 and the external power distribution terminal 350 (the positive side terminal 352 and the negative side terminal 353) to external devices on the basis of a detection signal transmitted from the thermistor 345 or a detection signal transmitted from each of the single batteries 100 or the assembled battery 200.

As the detection signal transmitted from the thermistor 345, for example, a signal indicating that a temperature of the single batteries 100 is detected to be a predetermined temperature or higher. As the detection signal transmitted from each of the single batteries 100 or the assembled battery 200, for example, a signal indicating detection of over-charge, over-discharge, and overcurrent of the single battery 100. When over-charge or the like is detected for each of the single batteries 100, the battery voltage may be detected, or a positive electrode potential or a negative electrode potential may be detected. In the latter case, a lithium electrode to be used as a reference electrode is inserted into each of the single batteries 100.

Note that, as the protective circuit 346, a circuit included in a device using the battery pack 300 as a power supply (for example, an electronic device, an automobile, or the like) may be used.

As described above, the battery pack 300 includes the external power distribution terminal 350. Therefore, the battery pack 300 can output a current from the assembled battery 200 to an external device and input a current from an external device to the assembled battery 200 via the external power distribution terminal 350. In other words, when the battery pack 300 is used as a power supply, the current from the assembled battery 200 is supplied to an external device via the external power distribution terminal 350. When the battery pack 300 is charged, a charging current from an external device is supplied to the battery pack 300 via the external power distribution terminal 350. When the battery pack 300 is used as an in-vehicle battery, regenerative energy of motive power of a vehicle can be used as the charging current from the external device.

The battery pack 300 may include a plurality of the assembled batteries 200. In this case, the plurality of assembled batteries 200 may be connected in series, may be connected in parallel, or may be connected in a combination of series connection and parallel connection. The printed wiring board 34 and the wire 35 may be omitted. In this case, the positive electrode side lead 207 and the negative electrode side lead 206 may be used as the positive side terminal and the negative side terminal of the external power distribution terminal, respectively.

Such a battery pack is used, for example, in applications where excellent cycle performance is demanded when a large current is extracted. Specifically, the battery pack is used as, for example, a power supply for electronic devices, a stationary battery, or an in-vehicle battery for various vehicles. Examples of the electronic devices may include a digital camera. The battery pack is particularly suitably used as an in-vehicle battery.

The battery pack according to the fourth embodiment includes the electrode according to the embodiment or the battery according to the embodiment. Therefore, the battery pack is excellent in charge and discharge performance, and can realize a high capacity.

### Fifth Embodiment

According to a fifth embodiment, there is provided a vehicle including the battery pack according to the embodiment.

In such a vehicle, the battery pack is configured, for example, to recover regenerative energy from motive power of the vehicle. The vehicle may include a mechanism (a regenerator) converting the kinetic energy of the vehicle to the regenerative energy.

Examples of the vehicle according to the embodiment include two-wheeled to four-wheeled hybrid electric automobiles, two-wheeled to four-wheeled electric automobiles, electrically assisted bicycles, and railway vehicles.

A mounting position of the battery pack in the vehicle according to the embodiment is not particularly limited. For example, when the battery pack is mounted in an automobile, the battery pack can be mounted in an engine compartment of the vehicle, in a rear part of the vehicle, or under a seat.

The vehicle according to the embodiment may include a plurality of battery packs mounted. In this case, batteries included in the respective battery packs may be electrically connected in series, may be electrically connected in parallel, or may be electrically connected in a combination of series connection and parallel connection. For example, when the respective battery packs include assembled batteries, the assembled batteries may be electrically connected in series, may be electrically connected in parallel, or may be electrically connected in a combination of series connection and parallel connection. Alternatively, when the respective battery packs include single batteries, the respective batteries may be electrically connected in series, may be electrically connected in parallel, or may be electrically connected in a combination of series connection and parallel connection.

Next, an example of the vehicle according to the embodiment will be described with reference to the drawings.

A vehicle 400 illustrated in FIG. 12 includes a vehicle body 40 and a battery pack 300 according to the embodiment. In the example illustrated in FIG. 12, the vehicle 400 is a four-wheeled automobile.

This vehicle 400 may include a plurality of the battery packs 300 mounted. In this case, batteries included in the battery pack 300 (for example, single batteries or assembled batteries) may be connected in series, may be connected in parallel, or may be connected in a combination of series connection and parallel connection.

An example in which the battery pack 300 is mounted in an engine compartment located at the front of the vehicle body 40 is illustrated in FIG. 12. As described above, the battery pack 300 may be mounted, for example, in a rear part of the vehicle body 40 or under a seat. The battery pack 300 can be used as a power supply of the vehicle 400. The battery pack 300 can also recover regenerative energy of motive power of the vehicle 400.

The vehicle according to the fifth embodiment includes the battery pack according to the embodiment installed. Therefore, the vehicle is excellent in charge and discharge performance and can realize a high capacity.

### Sixth Embodiment

According to a sixth embodiment, there is provided a stationary power supply including the battery pack according to the embodiment.

Such a stationary power supply may include the assembled battery according to the embodiment or the secondary battery according to the embodiment instead of the battery pack according to the embodiment. Such a stationary power supply is excellent in charge and discharge performance and can achieve a high capacity.

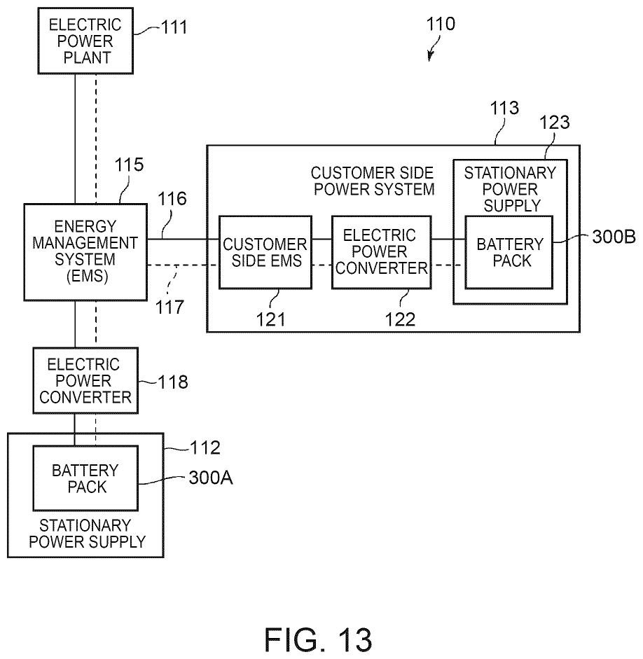

FIG. 13 is a view illustrating an application example to stationary power supplies 112 and 123 as an example of use of battery packs 300A and 300B according to the embodiment. In an example illustrated in FIG. 13, a system 110 in which the stationary power supplies 112 and 123 are used is illustrated. The system 110 includes an electric power plant 111, the stationary power supply 112, a customer side electric power system 113, and an energy management system (EMS) 115. An electric power network 116 and a communication network 117 are formed in the system 110, and the electric power plant 111, the stationary power supply 112, the customer side electric power system 113, and the EMS 115 are connected via the electric power network 116 and the communication network 117. The EMS 115 performs control to stabilize the entire system 110 by utilizing the electric power network 116 and the communication network 117.

The electric power plant 111 generates a large amount of electric power from fuel sources such as thermal power and nuclear power. Electric power is supplied from the electric power plant 111 through the electric power network 116 and the like. A battery pack 300A is mounted in the stationary power supply 112. The battery pack 300A can store electric power and the like supplied from the electric power plant 111. The stationary power supply 112 can supply the electric power stored in the battery pack 300A through the electric power network 116 and the like. The system 110 is provided with an electric power converter 118. The electric power converter 118 includes a converter, an inverter, a transformer, and the like. Thus, the electric power converter 118 can perform conversion between a direct current and an alternate current, conversion between alternate currents of frequencies different from each other, voltage transformation (step-up and step-down), and the like. Therefore, the electric power converter 118 can convert electric power from the electric power plant 111 into electric power that can be stored in the battery pack 300A.

The customer side electric power system 113 includes an electric power system for factories, an electric power system for buildings, an electric power system for home use, and the like. The customer side electric power system 113 includes a customer side EMS 121, an electric power converter 122, and the stationary power supply 123. A battery pack 300B is mounted in the stationary power supply 123. The customer side EMS 121 performs control to stabilize the customer side electric power system 113.

Electric power from the electric power plant 111 and electric power from the battery pack 300A are supplied to the customer side electric power system 113 through the electric power network 116. The battery pack 300B can store electric power supplied to the customer side electric power system 113. Similarly to the electric power converter 118, the electric power converter 122 includes a converter, an inverter, a transformer, and the like. Thus, the electric power converter 122 can perform conversion between a direct current and an alternate current, conversion between alternate currents of frequencies different from each other, voltage transformation (step-up and step-down), and the like. Therefore, the electric power converter 122 can convert electric power supplied to the customer side electric power system 113 into electric power that can be stored in the battery pack 300B.

The electric power stored in the battery pack 300B can be used, for example, for charging a vehicle such as an electric automobile. The system 110 may be provided with a natural energy source. In this case, the natural energy source generates electric power by natural energy such as wind power and solar light. In addition to the electric power plant 111, electric power is also supplied from the natural energy source through the electric power network 116.

### EXAMPLES

Hereinafter, the above-described embodiments will be specifically described with reference to examples, but the invention is not limited to the following examples.

### Example 1

An electrode was prepared as follows.

### <Preparation of Current Collector>

Titanium fibers having a fiber diameter of 100 μm were held at 1600° C. for 5 hours in an Ar atmosphere to be sintered, and were shaped by polishing and cutting to obtain a titanium porous plate having a thickness of 1 mm and 2 cm square.

### <Preparation of Negative Electrode>

First, 100 parts by weight of active material (Li₄Ti₅O₁₂), 10 parts by weight of conductive agent (acetylene black), and 5 parts by weight of binder (polyvinylidene fluoride (PVdF)) were dispersed in an N-methylpyrrolidone (NMP) solvent to prepare a slurry having a solid content of 40%. The titanium porous plate was impregnated with the prepared slurry, and was allowed to stand at −60 kPa for 5 minutes. The plate was taken out, a surface thereof was wiped, and the plate was allowed to stand in a thermostatic chamber at 120° C. for 1 hour to be dried. The weight of a supported negative electrode mixture layer was measured, and impregnation with slurry and drying were appropriately repeated to adjust the mass per unit area of the electrode to 300 g/m². Thereafter, one surface was polished to expose the titanium metal, thereby preparing a negative electrode.

### <Preparation of Positive Electrode>

First, 100 parts by weight of active material (LiMn₂O₄), 10 parts by weight of conductive agent (acetylene black), and 5 parts by weight of binder (polyvinylidene fluoride (PVdF)) were dispersed in an N-methylpyrrolidone (NMP) solvent to prepare a slurry having a solid content of 40%. The titanium porous plate was impregnated with the prepared slurry, and was allowed to stand at −60 kPa for 5 minutes. The plate was taken out, a surface thereof was wiped, and the plate was allowed to stand in a thermostatic chamber at 120° C. for 1 hour to be dried. The impregnation with slurry and drying were appropriately repeated to adjust the mass per unit area of the electrode to 600 g/m². Thereafter, one surface was polished to expose the titanium metal, thereby preparing a positive electrode.

### <Preparation of Electrolyte>

An aqueous solution of LiN (CF₃SO₂)₂(LiTFSI) having a concentration of 20 mol/L was prepared and used as an electrolytic solution.

### <Assembly of Secondary Battery>

A glass filter was sandwiched between the produced negative electrode and positive electrode as a separator, and both sides were sandwiched between titanium plates as terminals, and fixed and pressure-bonded from the outside with a polypropylene plate to prepare an electrode group. The surface of the electrode where the titanium metal was exposed was brought into contact with the titanium plate to secure conductivity. Thereafter, the electrode group was placed in a beaker, 20 mL of electrolytic solution was injected into the beaker, and the beaker was held at −80 kPa for 10 minutes to impregnate the electrode group with the electrolytic solution.

### <Battery Evaluation and Measurement of First and Second Porosities>

In battery evaluation, the battery was repeatedly charged and discharged five times at 2.7 to 1.5 V and a current value of 100 mA (corresponding to 1 C rate). The charge and discharge efficiency at the time of five times and the capacity per unit weight of the negative electrode active material were measured.

With respect to the first porosity, a cut surface in a thickness direction was cut out from the obtained titanium porous plate by using a focused ion beam (FIB), and observation was performed using a scanning electron microscope (SEM). Cross-section processing in the same direction by FIB and observation by SEM were repeated 100 times. An FIB processing pitch was approximately 150 nm. Energy dispersive X-ray spectroscopy (EDX) was used during the SEM observation, a mapping image of a titanium element was binarized by image analysis, and a ratio of an area of a void area (other than the current collector) to a total area of the image was calculated.

The second porosity was measured by cutting the prepared electrode into 2 cm square, and acquiring a pore distribution by mercury porosimetry.

The first and second porosities were not changed even when the battery was disassembled and measured after the battery evaluation.

### Example 2

Example 2 was similar to Example 1 except that titanium fibers having a fiber diameter of 50 μm were used.

### Example 3

Example 3 was similar to Example 1 except that titanium fibers having a fiber diameter of 20 μm were used.

### Example 4

Titanium fibers having a fiber diameter of 20 μm were used, and a nonwoven fabric was prepared without sintering. The prepared nonwoven fabric was cut into 2 cm square to obtain a current collector having a thickness of 1 mm. Example 4 was similar to Example 1 except for a method of preparing a current collector.

### Example 5

Example 5 was similar to Example 1 except that aluminum was used as a metal of the current collector.

### Comparative Example 1

Comparative Example 1 was similar to Example 1 except that a titanium foil having a thickness of 20 μm was used as a current collector, and a slurry was applied to a surface of the current collector to prepare an electrode.

### Comparative Example 2

Comparative Example 2 was similar to Example 1 except that an aluminum foil having a thickness of 20 μm was used as a current collector, and a slurry was applied to a surface of the current collector to prepare an electrode.

### Comparative Example 3

Comparative Example 3 was similar to Example 1 except that a titanium mesh having a fiber diameter of 0.2 mm and an opening of 1.3 mm was used as a current collector, and a slurry was applied to the surface of the current collector to prepare an electrode.

### Comparative Example 4

Comparative Example 4 was similar to Example 1 except that a titanium mesh having a fiber diameter of 0.4 mm and an opening of 1.0 mm was used as a current collector, and a slurry was applied to the surface of the current collector to prepare an electrode.

### Comparative Example 5

Comparative Example 5 was similar to Example 4 except that the fiber diameter was set to 1 μm.

The results obtained in Examples 1 to 5 and Comparative Examples 1 to 5 are shown in Table 1.

TABLE 1

| | | | | | Average |
|---|---|---|---|---|---|
| | Porosity of | | Charge and | Negative | curved path |
| | current | Porosity of | discharge | electrode | ratio of |
| | collector | electrode | efficiency | capacity | current |
| | (%) | (%) | (%) | (mAh/g) | collector (—) |
| Example 1 | 85 | 70 | 95 | 130 | 1.20 |
| Example 2 | 80 | 68 | 97 | 141 | 1.21 |
| Example 3 | 77 | 62 | 98 | 152 | 1.25 |
| Example 4 | 89 | 78 | 98 | 154 | 1.44 |
| Example 5 | 88 | 77 | 96 | 154 | 1.43 |
| Comparative | 0 | 40 | 46 | 32 | Calculation |
| Example 1 | | | | | is impossible |
| Comparative | 0 | 36 | 76 | 93 | Calculation |
| Example 2 | | | | | is impossible |
| Comparative | 75 | 47 | 53 | 47 | 1.00 |
| Example 3 | | | | | |
| Comparative | 64 | 23 | 50 | 55 | 1.00 |
| Example 4 | | | | | |
| Comparative | 95 | 71 | 72 | 83 | 1.23 |
| Example 5 | | | | | |

As is apparent from Table 1, batteries of Examples 1 to 5 including the current collector having the first porosity of 70% or more and 90% or less, and the electrode including the current collector and the active material-containing portion and having the second porosity of 60% or more and 80% or less exhibited high charge and discharge efficiency and a large capacity per unit weight of the negative electrode. The reason for this is that by satisfying the first porosity range, the specific surface area of the current collector can be increased while maintaining the current collection performance, and the amount of the active material that can be supported increases. Furthermore, it is considered that by satisfying the second porosity range, the electrolyte was impregnated into the inside of the electrode and the reactivity with the active material supported on the current collector was enhanced.

According to one or more embodiments and examples described above, an electrode is provided. The electrode includes a current collector and an active material-containing portion. A first porosity of a current collector is 70% to or more and 90% or less, and a second porosity of the electrode is 60% or more and 80% or less. The electrode according to the embodiment can provide a secondary battery and a battery pack that are excellent in charge and discharge performance and have a high capacity, and a vehicle and a stationary power supply including the battery pack.

Even though some embodiments of the invention have been described, these embodiments are presented as examples and are not intended to limit the scope of the invention. These novel embodiments can be implemented in various other modes, and various omissions, replacements, and changes can be made without departing from the gist of the invention. These embodiments and modifications thereof are included in the scope and gist of the invention, and are included in the scope of the invention described in the claims and the equivalent scope thereof.

Hereinafter, the invention of the embodiment will be additionally described.

<1>

An electrode, including:
a current collector; and
an active material-containing portion,
the current collector has a first porosity, and the electrode including the current collector and the active material-containing portion has a second porosity, wherein
the first porosity is 70% or more and 90% or less and the second porosity is 60% or more and 80% or less.
   <2>

The electrode according to <1>, wherein the active material-containing portion is supported on the current collector.

<3>

The electrode according to <1> or <2>, wherein the current collector contains metal fibers, and an average curved path ratio inside the current collector is 1.3 or more and 2.5 or less.

<4>

The electrode according to any one of <1> to <3>, wherein a fiber diameter of the metal fibers is 1 μm or more and 100 μm or less.

<5>

The electrode according to any one of <1> to <4>, wherein the thickness of the current collector is 1 mm or more and 50 mm or less.

<6>

The electrode according to any one of <1> to <5>, wherein the active material-containing portion includes an active material, a conductive agent, and a binder.

<7>

A secondary battery, including:
a positive electrode;
a negative electrode; and
an electrolyte,
wherein at least one of the positive electrode and the negative electrode is the electrode according to any one of <1> to <6>.
   <8>

A battery pack including the secondary battery according to <7>.

<9>

The battery pack according to <8>, further including:
an external power distribution terminal; and
a protective circuit.
   <10>

The battery pack according to <8> or <9>, wherein the battery pack includes a plurality of the secondary batteries, and the secondary batteries are electrically connected in series, in parallel, or in combination of series and parallel.

<11>

A vehicle including the battery pack according to any one of <8> to <10>.

<12>

The vehicle according to <11>, wherein the vehicle includes a mechanism configured to convert kinetic energy of the vehicle into regenerative energy.

<13>

A stationary power supply including the battery pack according to any one of <8> to <10>.

What is claimed is:

1. An electrode, comprising:
a current collector; and
an active material-containing portion,
the current collector has a first porosity, and the electrode including the current collector and the active material-containing portion has a second porosity, wherein
the first porosity is 70% or more and 90% or less and the second porosity is 60% or more and 80% or less.

2. The electrode according to claim 1, wherein the active material-containing portion is supported on the current collector.

3. The electrode according to claim 1, wherein the current collector contains metal fibers, and an average curved path ratio inside the current collector is 1.3 or more and 2.5 or less.

4. The electrode according to claim 3, wherein a fiber diameter of the metal fibers is 1 μm or more and 100 μm or less.

5. The electrode according to claim 1, wherein a thickness of the current collector is 1 mm or more and 50 mm or less.

6. The electrode according to claim 1, wherein the active material-containing portion includes an active material, a conductive agent, and a binder.

7. A secondary battery, comprising:
a positive electrode;
a negative electrode; and
an electrolyte,
wherein at least one of the positive electrode and the negative electrode is the electrode according to claim 1.

8. A battery pack comprising the secondary battery according to claim 7.

9. The battery pack according to claim 8, further comprising:
an external power distribution terminal; and
a protective circuit.

10. The battery pack according to claim 8, comprising a plurality of the secondary batteries,
wherein the secondary batteries are electrically connected in series, in parallel, or in combination of series and parallel.

11. A vehicle comprising the battery pack according to claim 8.

12. The vehicle according to claim 11, wherein the vehicle includes a mechanism configured to convert kinetic energy of the vehicle into regenerative energy.

13. A stationary power supply comprising the battery pack according to claim 8.
